(19) United States
(12) Patent Application Publication
(10) Pub. No.: US 2006/0000962 A1
(43) Pub. Date: Jan. 5, 2006

(54) Biological sample observation system and biological sample observation method

(75) Inventors: Hiroyuki Imabayashi, Tokyo (JP); Kayuri Muraki, Tokyo (JP); Yoshimasa Suzuki, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/149,691

(22) Filed: Jun. 10, 2005

(30) Foreign Application Priority Data
Jun. 17, 2004 (JP) 2004-180064

(51) Int. Cl. G02B 27/40

(52) U.S. Cl. 250/201.2

(57) ABSTRACT

An object is to provide a biological sample observation system wherein light damage to the biological sample is decreased, and observation can be performed accurately and quickly over a long period of time. A biological sample observation system which continuously obtains information on a biological sample that is cultured inside of a culturing container has: an imaging section which observes mutually different regions that are previously selected, among regions to be observed including the biological sample, through an object lens for observing the biological sample in the culturing container through a part of the culturing container; an autofocus section which detects the focusing of the object lens with respect to a predetermined region among the regions to be observed; and a focusing drive control section which controls the focusing of the object lens when the biological sample is observed using the imaging section, based on the detection result of the focusing previously performed by the autofocus section. After the focus detection is performed by the autofocus section, without being intervened by the focus detection using the autofocus section, and the different regions are continuously observed by the imaging section, with the focusing controlled by the focusing drive control section.

### BACKGROUND OF THE INVENTION

1. Field of the Invention

The present invention relates to autofocusing on a cultured biological sample, used in a device which detects information caused by the reaction of the biological sample being cultured.

This application is based on Japanese Patent Application No. 2004-180064, the content of which is incorporated herein by reference.

2. Description of Related Art

Recently, automation of various functions of survey instruments using a microscope is in progress, and an autofocus function for focusing on a specimen has been an essential function for automation.

The microscope autofocus is also employed for a survey instrument for a specimen sealed in a slide glass. For example, there is known an autofocus technique using an infrared reflection film as disclosed in Japanese Unexamined Patent Application, First Publication No. Hei08-82747. Furthermore, there is known a technique wherein a slide glass or a cover glass is focused on by an active AF system, then a specimen is accurately focused on using a passive AF system, as disclosed in Japanese Unexamined Patent Application, First Publication No. 2001-91821.

The system using the microscope as mentioned above has been largely used for observing cells in a culturing process in a culturing container or the like.

Here, in order to grow cells in a culturing container, it has been needed to keep the environment of the culture such as the thermal environment at approximately 37° C., the carbon dioxide concentration in the culture gas at about 5%, and so on. Therefore, due to the temperature drift due to the temperature control for keeping the environment of the culture, the effect of cooling due to flowing of the culture gas, and the heating of a lamp house, and the like, thermal deformation of the mainframe components or the subject of observation readily occurs, and in the technique disclosed in Patent Document 1 and Patent Document 2, there is concern of frequent defocusing where the focal point is displaced with the passage of time.

Cells to be observed range over various types, and have a thickness of 5 to 10 μm on the average. Non-confocal observation measurement, confocal observation measurement, or the like are used according to the object of the observation, and an object lens of a high magnification has been used in many cases. Therefore, together with the abovementioned reasons, there has been concern of frequent defocusing where the focal position is displaced.

Therefore, in an observation device taking the form of a microscope, an autofocus operation has been performed at each time during observation of cells, so as to prevent defocusing. However, if an autofocus operation is performed at each time during the observation, there has been a problem of extending the time for observation due to the autofocus operation.

If the time for observation is extended, for example in a case of observing a large number of cells, the time interval from the observation of the first cell to the observation of the last cell becomes longer, causing a problem in that the results can not be dealt with as observation results for the same time.

That is, since cells change with the passage of time, the time for observation must also be controlled accurately in order to perform accurate observation. However, if as mentioned above the time of observation differs depending on the order of observation, there is a problem in that accurate results can not be obtained, even if sets of information obtained by observation are compared.

If a laser is used for the active autofocus, laser light is always irradiated on the cells. Therefore the time for photoirradiation of the cells is also increased. If the time for photoirradiation is extended, the concentration of active oxygen in the cells is increased, causing a problem in that the active oxygen damages the cells in the culturing process.

### BRIEF SUMMARY OF THE INVENTION

The present invention was achieved in order to solve the above problems, and has an object to provide a biological sample observation system wherein light damage to the biological sample is decreased, and observation can be performed accurately and quickly over a long period of time.

In order to achieve the above object, the present invention provides the following means.

A biological sample observation system of the present invention which continuously obtains information on a biological sample that is cultured inside of a culturing container has: an imaging section which observes mutually different regions that are previously selected, among regions to be observed including the biological sample, through an object lens for observing the biological sample in the culturing container through a part of the culturing container; an autofocus section which detects the focusing of the object lens with respect to a predetermined region among the regions to be observed; and a focusing drive control section which controls the focusing of the object lens when the biological sample is observed using the imaging section, based on the detection result of the focusing previously performed by the autofocus section. After the focus detection is performed by the autofocus section, without being intervened by the focus detection using the autofocus section, and the different regions are continuously observed by the imaging section, with the focusing controlled by the focusing drive control section.

A biological sample observation system of the present invention which continuously obtains information on a biological sample that is cultured inside of a culturing container has: an observation device which observes mutually different regions that are previously selected, among regions to be observed including the biological sample, through an object lens for observing the biological sample in the culturing container through a part of the culturing container; an autofocus device which detects the focusing of the object lens with respect to a predetermined region among the regions to be observed; and a focusing drive control device which controls the focusing of the object lens when the biological sample is observed using the observation device, based on the detection result of the focusing previously performed by the autofocus device. After the focus detection is performed by the autofocus device, without being intervened by the focus detection using the autofocus section, and the mutually different regions are continuously observed by the observation device, with the focusing controlled by the focusing drive control device.

A biological sample observation method of the present invention in which information on a biological sample that is cultured inside of a culturing container is continuously obtained includes: a step for detecting by an autofocus section, the focusing of an object lens for observing a biological sample through a part of the culturing container, with respect to a predetermined region among the regions to be observed including the biological sample in the culturing container; a step for controlling by a focusing drive control section, the focusing of the object lens when the biological sample is observed, based on the detection result of the focusing previously performed by the autofocus section; and a step for observing through the object lens by an imaging section, mutually different regions that are previously selected, among the regions to be observed, with the focusing controlled by the focusing drive control section. After the focus detection is performed by the autofocus section, without being intervened by the focus detection using the autofocus section, and the different regions are continuously observed by the imaging section, with the focusing controlled by the focusing drive control section.

### BRIEF DESCRIPTION OF THE SEVERAL VIEWS OF THE DRAWINGS

FIG. 1 is a perspective view showing a biological sample observation system according to a first embodiment of the present invention.

FIG. 2 is a schematic diagram showing the system structure of the biological sample observation system of FIG. 1.

FIG. 3 is a schematic diagram showing the structure of an AF unit 46 of FIG. 2.

FIG. 4 is a perspective view showing an incubator box of FIG. 1.

FIG. 5 is a perspective view showing another example of the incubator box in the present embodiment.

FIG. 6 is a cross-sectional view of a chamber of FIG. 5.

FIG. 7A shows an example of a selected example of a scan method and a detection range in the present embodiment.

FIG. 7B shows another example of a selected example of the scan method and the detection range in the present embodiment.

FIG. 7C shows yet another example of a selected example of the scan method and the detection range in the present embodiment.

FIG. 7D shows yet another example of a selected example of the scan method and the detection range in the present embodiment.

FIG. 8 is a flowchart showing the flow of measurement parameter setting in the present embodiment.

FIG. 9A shows an observation area on a slide glass in the present embodiment.

FIG. 9B shows an area on the slide glass in which the focal position is measured in the present embodiment.

FIG. 10A shows a linear interpolation in the present embodiment.

FIG. 10B shows a curvilinear interpolation in the present embodiment.

FIG. 11 shows the observation area and the area on the slide glass in which the focal position is measured in the present embodiment.

FIG. 12 is a flowchart showing the flow of measurement in the present embodiment.

FIG. 13 is a flowchart showing an image processing method in the present embodiment.

FIG. 14 is a flowchart showing the flow of data processing in the present embodiment.

FIG. 15 is a flowchart showing the flow of light quantity adjustment in the present embodiment.

FIG. 16 is a flowchart showing a supplying/exchanging method of a culture solution in the present embodiment.

FIG. 17 shows a tracked image of cells, showing the change of cells with the passage of time.

FIG. 18 is a flowchart showing the flow of measurement according to a second embodiment of the present invention.

### DETAILED DESCRIPTION OF THE INVENTION

### First Embodiment

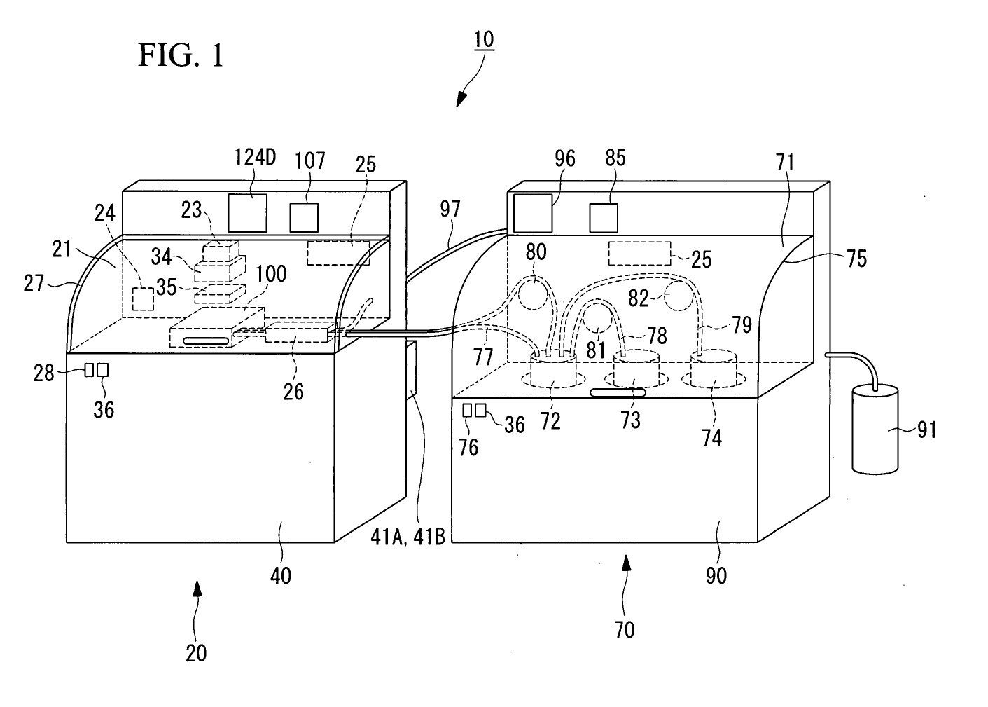

Hereunder is a description of a biological sample observation system according to a first embodiment of the present invention, with reference to FIG. 1 to FIG. 17.

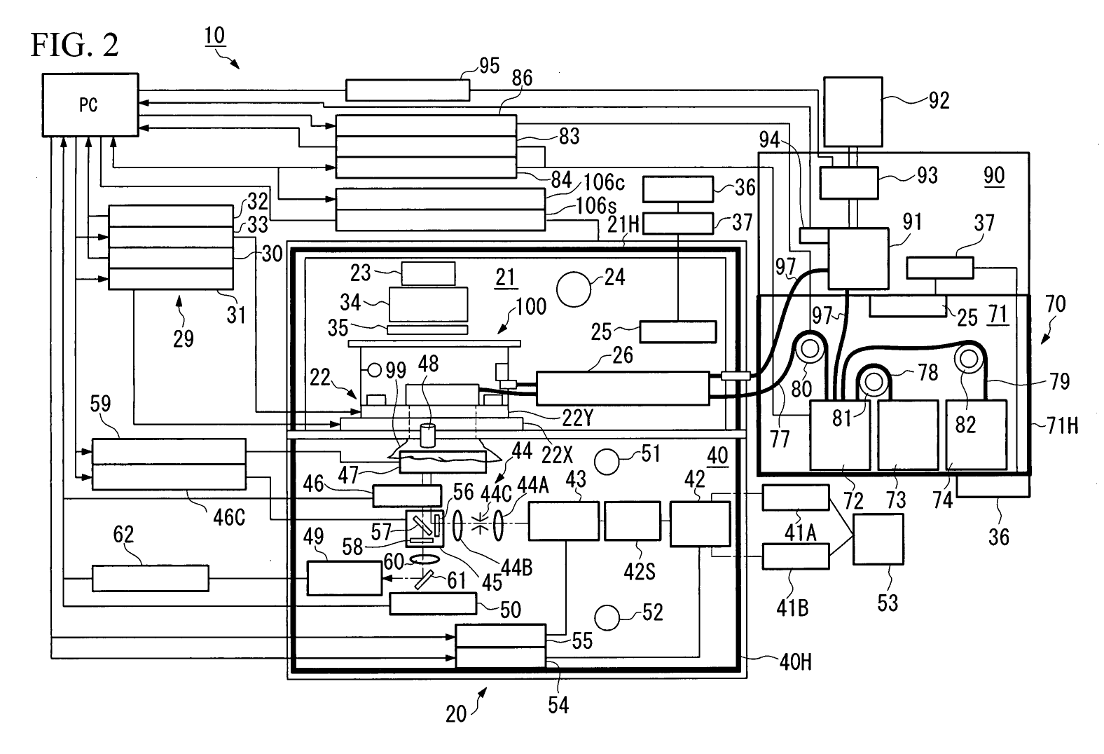

FIG. 1 is a perspective view showing the outline of the biological sample observation system according to the present embodiment. FIG. 2 is a schematic diagram showing the system structure of the biological sample observation system thereof.

As shown in FIG. 1 and FIG. 2, a biological sample observation system 10 schematically comprises a detection unit 20, and a culturing unit 70. The detection unit 20 and the culturing unit 70 are desirably arranged close to each other. More preferably, these units 20 and 70 are arranged in contact with each other.

As shown in FIG. 1 and FIG. 2, the detection unit 20 schematically comprises a heat-insulating box 21 for containing cells (biological sample) CE inside, and a detection section 40 which measures the cells CE.

The heat insulating box 21 comprises; a heater (temperature maintaining section) 21H which keeps the inside of the heat insulating box 21 warm at a predetermined temperature, a stage (holding device) 22 which holds an incubator box (culturing container) 100 described later, a transmission light source 23 which irradiates light to the cells CE, a fan 24 which makes uniform the temperature inside of the heat insulating box 21, a UV lamp 25 which sterilizes the inside of the heat insulating box 21, a carrier 26 which protects a culture solution circulation pipeline 77 and a culture gas supply pipeline 97 described later, an opening/shutting door 27 which is used for putting in and taking out the incubator box 100 or the like from the heat insulating box 21, and a main power switch 28 which turns ON/OFF the main power source of the detection unit 20.

The stage 22 has an X axis operation stage (holding device) 22X, and a Y axis operation stage (holding device) 22Y which are relatively moved in the mutually orthogonal directions, and scanning is controlled by a stage scanning section 29.

The stage scanning section 29 comprises; an X axis coordinate detection section 30 which detects the X axis coordinate value of the X axis operation stage 22X, an X axis scanning control section 31 which controls the operation (scan) of the X axis operation stage 22X, a Y axis coordinate detection section 32 which detects the Y axis coordinate value of the Y axis operation stage 22Y, and a Y axis scanning control section 33 which controls the operation (scan) of the Y axis operation stage 22Y.

The X axis coordinate detection section 30 and the Y axis coordinate detection section 32 are arranged to respectively output the detected X coordinate of the X axis operation stage 22X and Y coordinate of the Y axis operation stage 22Y to a computer PC. The X axis scanning control section 31 and the Y axis scanning control section 33 are arranged to respectively control the scan of the X axis operation stage 22X and the scan of the Y axis operation stage 22Y, based on the instructions from the computer PC.

An example of a mechanism which drives the X axis operation stage 22X and the Y axis operation stage 22Y includes for example a combination of a motor and a ball screw.

The computer PC also controls the detection system of the cells CE, and analyzes the captured image of the cells CE as described later, as well as controlling the scan of the X axis operation stage 22X and the scan of the Y axis operation stage 22Y as described above. The X axis operation stage 22X, the Y axis operation stage 22Y, the detection system, and the analysis system, are controlled linked together.

A condenser lens 34 which focuses the light emitting from the transmission light source 23 onto the cells CE, is arranged between the transmission light source 23 and the incubator box 100.

A shutter 35 may be provided between the condenser lens 34 and the incubator box 100, or the shutter 35 may not be provided.

The fan 24 is arranged on the wall surface of the heat insulating box 21. By operating the fan 24, the air in the heat insulating box 21 is convected so that the temperature in the heat insulating box 21 can be readily kept uniform and constant.

The UV lamp 25 is connected to a UV lamp switch 36 arranged on the wall surface of the detection unit 20. A timer 37 which controls the operation of the UV lamp 25 timewise is arranged between the UV lamp 25 and the UV lamp switch 36. Furthermore, there is arranged a sterilization indicator lamp (not shown) which indicates if the UV lamp 25 is turned on.

For example, if the UV lamp switch 36 is pressed when the cells CE are not being measured, the counting of the timer 37 is started and the power is supplied to the UV lamp 25, and UV light (ultraviolet light) is irradiated into the heat insulating box 21. At the same time, the sterilization indicator lamp is also turned on. Then, after a predetermined time (for example, 30 minutes) has passed and the counting of the timer 37 is terminated, the timer 37 stops the power supply to the UV lamp 25 to terminate the irradiation of UV light. Moreover, the sterilization indicator lamp is also turned off.

The UV lamp 25 is controlled separately from the main power switch 28, and can be operated even if the main power source is turned off.

The lighting time of the UV lamp 25 may be 30 minutes as mentioned above, or may be less than 30 minutes or longer than 30 minutes as long as the time allows the various bacteria in the heat insulating box 21 to be completely killed.

The opening/shutting door 27 is made from a metal such as an alumite coated aluminum, or a semitransparent resin having a high shading property. The structure of the opening/shutting door 27 is considered to be a hollow dual structure, and furthermore a structure having the aforementioned metal for the inside and resin for the outside.

By using the resin for the outside of the opening/shutting door 27, the heat in the heat insulating box 21 can be kept from escaping from the opening/shutting door 27 to the outside. Moreover, using the alumite coated metal for the inside of the opening/shutting door 27, deterioration in the lifetime of the opening/shutting door 27 due to the UV lamp 25 can be avoided.

If the opening/shutting door 27 has the dual structure of a metal or a metal and a resin, it is completely shaded. Therefore an observation window is desirably provided in a position to enable peeping into the incubator box 100. Desirably a transparent resin or a glass is fitted into the peephole, and an openable and closable cover is arranged on the outside.

As shown in FIG. 1 and FIG. 2, the detection section 40 comprises; a heater (temperature maintaining section) 40H which keeps the inside of the detection section 40 warm at a predetermined temperature (for example, 37° C.), incident light sources 41A and 41B which irradiate the cells CE from the detection section 40 side, an optical path switch section 42 which switches the optical paths from the incident light sources 41A and 41B, a light quantity adjustment mechanism 43 which adjusts the light quantity of the irradiation light, a lens system 44 which focuses the irradiation light towards the cells CE, a filter unit 45 which controls the wavelength of the irradiation light and the wavelength of the detection light, an autofocus (AF) unit (autofocus section, autofocus device) 46 which performs the focusing operation on the cells CE, a revolver 47 comprising object lenses 48 having a plurality of magnifications and different properties, a detector (observation device) 49 which detects the detection light from the cells CE, a light quantity monitor 50 which measures the light quantity of the detection light, a fan 51 which makes uniform the temperature inside of the detection section 40, and a cooling fan 52 which cools the inside of the detection section 40.

The incident light sources 41A and 41B comprise for example mercury lamps or the like, and are arranged outside of the detection section 40, and are respectively connected to a power source 53 which supplies their power.

Moreover, normally one incident light source, for example the incident light source 41A is used. However, if the light quantity of the incident light source 41A drops below a predetermined prescribed value, the illuminating light is irradiated from the incident light source 41B, and the power source of the incident light source 41A is turned off.

The optical path switch section 42 is formed to lead either one of the illuminating light from the incident light source 41A or the illuminating light from the incident light source 41B to the light quantity adjustment mechanism 43. Moreover in the optical path switch section 42 there is arranged an optical path control section 54 which is connected to the computer PC described later to control the optical path switch section 42, based on an instruction from the computer PC.

A shutter 42S is arranged on the illuminating light emission side of the optical path switch section 42, so as to perform transmission/shutdown control of the illuminating light.

A light quantity adjustment mechanism 43 is arranged on the illuminating light emission side of the shutter 42S, so as to adjust the light quantity of the illuminating light transmitted through the shutter 42S. As the mechanism, a well-known aperture mechanism may be used, or some other well-known mechanism and technique that can adjust the light quantity may be used.

Moreover, in the light quantity adjustment mechanism 43 there is arranged a light quantity control section 55 which is connected to the computer PC described later to control the light quantity adjustment mechanism 43 based on an instruction from the computer PC.

A lens system 44 is arranged on the illuminating light emission side of the light quantity adjustment mechanism 43. The lens system 44 comprises a pair of lenses 44A and 44B, and an aperture 44C arranged between the lens 44A and the lens 44B.

The filter unit 45 comprises an excitation filter 56, a dichroic mirror 57, and an absorption filter 58. The excitation filter 56 is one which passes light (exciting light) having a wavelength that contributes to the fluorescence of the cells CE, among the illuminating light, and is arranged so that the illuminating light emitting from the lens system 44 is incident into the excitation filter 56. The dichroic mirror 57 is an optical element that separates exciting light and fluorescent light. The dichroic mirror 57 is arranged so that the exciting light transmitted through the excitation filter 56 is reflected towards the cells CE, and the fluorescent light from the cells CE is transmitted. The absorption filter 58 is an optical element that separates fluorescent light from the cells CE, and the other unnecessary scattered light, and is arranged so that the light transmitted through the dichroic mirror 57 is incident thereinto.

A filter control section 46C which controls the wavelength of the exciting light or the detection light (fluorescent light) emitting from the filter unit 45 based on an instruction from the computer PC described later, is arranged in the filter unit 45.

One of each excitation filter 56, dichroic mirror 57, and absorption filter 58 may be used, or a plurality of them may be used.

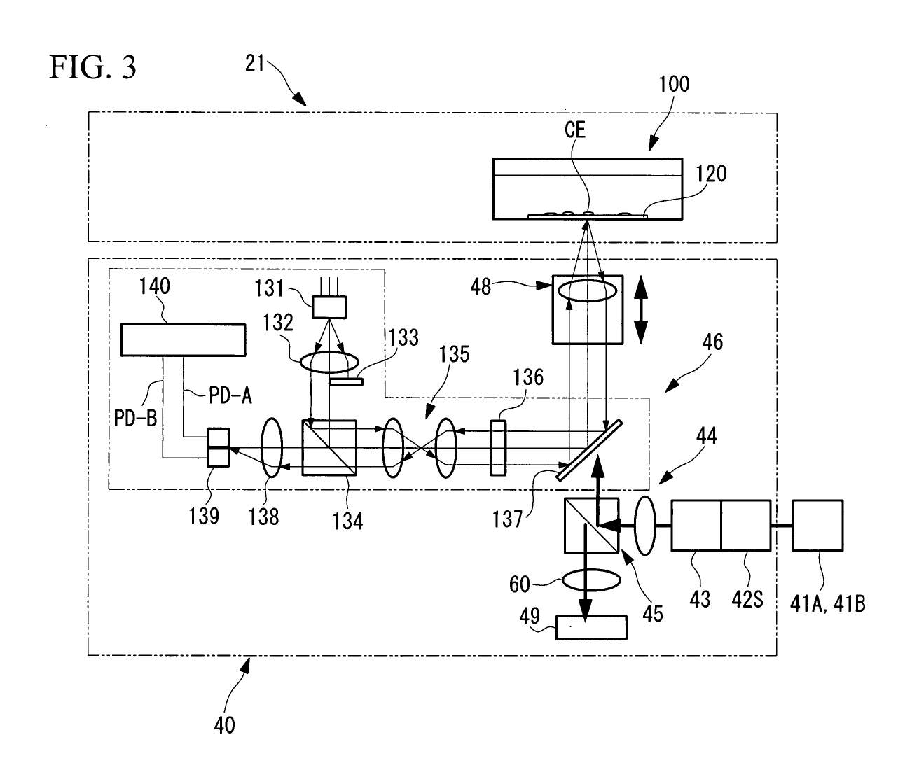

FIG. 3 shows the schematic structure of the AF unit 46.

As shown in FIG. 2 and FIG. 3, the AF unit 46 is arranged on the exciting light emission side of the filter unit 45, so that the exciting light is focussed onto the cells CE through the object lens 48, based on the instruction from the computer PC described later.

More specifically, the AF unit 46 is constituted as an active AF light receiving system including a floodlighting device. In the AF unit 46, the arrangement is such that the laser light emitting from the laser light source (LD) 131 is incident into a collimate lens 132 and converted into a parallel light flux, a half of the parallel light flux is shut by a shielding plate 133, the P polarized component of the laser light flux that was not shut by the shielding plate 133 is reflected towards an imaging lens system 135 by a polarized beam splitter 134, and the S polarized component thereof is transmitted.

The arrangement is such that the P polarized light transmitted through the imaging lens system 135 is converted into an elliptical polarized light by a quarter wave plate 136, and reflected by a dichroic mirror 137 towards a microplate 120 or a chamber 110.

The elliptical polarized light reflected against the dichroic mirror 137 is irradiated onto the microplate 120 or the chamber 110, and reflected as elliptical polarized light by the microplate 120 or the chamber 110. The reflected elliptical polarized light is reflected against the dichroic mirror, incident into the quarter wave plate 136, converted into an S polarized light, and emitted therefrom. The S polarized light is transmitted through the imaging lens system 135 and the polarized beam splitter 134, and incident into the imaging lens 138. The S polarized light incident into the imaging lens 138 is arranged so as to form the imaged thereof on an active two-split detector (PD) 139.

The optical components are set on the same optical axis, and the dichroic mirror 137 is also set on the optical axis of the object lens 48.

The PD 139 is arranged so that two signals PD-A and PD-B are outputted to an active AF signal generation section.140. The active AF signal generation section 140 generates an active AF signal showing the defocus amount and the defocus direction, based on the magnitude and the difference of the two signals PD-A and PD-B.

An optical element that reflects only the laser light emitting from the LD131 or the laser light reflected by the microplate 120 or the chamber 110, is used for the dichroic mirror 137.

As described above, the AF unit 46 may be an optical system that performs active focus, may be an optical system that performs passive autofocus, or may be a system that performs focusing by an other well-known method.

As shown in FIG. 2, the revolver 47 is arranged on the exciting light emission side of the AF unit 46, and is arranged with a plurality of object lenses 48 having a plurality of magnifications. For the object lens 48, there is arranged an object lens control section (focusing drive section) 59 including a highly accurate feed mechanism that can move the object lens 48 in the Z direction (direction for approaching or separating from the relative position with respect to the cells CE).

The object lens control section (focusing drive section) 59 drives the revolver 47 based on an instruction from the computer (focusing drive control section, focusing drive control device) PC, so as to select an object lens 48 into which the exciting light is shone, and control the focal position of the object lens 48 by the feed mechanism.

As the feed mechanism, for example, a mechanism comprising a cross roller guide, a ball screw, or a stepping motor may be used, or a mechanism using an other actuator such as a piezoelectric element may be used.

The object lens 48 has a structure where the inside of the incubator box in the heat insulating box 21 can be observed from the detection section 40 through holes respectively provided in the X axis operation stage 22X and the Y axis operation stage 22Y.

For the X axis operation stage 22X and the Y axis operation stage 22Y, the size of the holes includes some leeway to allow for a range wherein the stage is operated.

Therefore, even though the atmosphere in the heat insulating box 21 is kept at a temperature suitable for the cell culture, the atmosphere escapes through the holes to the detection section 40, so the temperature suitable for the cell culture can not be maintained, causing the likelihood that the cell activity is decreased.

Here, there may be provided a restraining device 99 which restrains such an atmosphere at the temperature suitable for the cell culture, from passing through between the heat insulating box 21 and the detection section 40.

The restraining device 99 may be any form as long as the movement of the revolver 47 and the object lenses 48 are not interrupted. For example, it is considered to be in film form having a sheet made from a soft material such as a film or a transparent sheet adhered around the hole provided on the border between the heat insulating box 21 and the detection section 40, and attached so as to hang down around the revolver.

A condenser lens 60 which focuses the detection light onto the detector 49 and the light quantity monitor 50, is arranged on the detection light emission side of the filter unit 45.

A half mirror 61 which reflects a part of the detection light towards the detector 49 and lets the rest of the detection light pass through towards the light quantity monitor 50, is arranged on the detection light emission side of the condenser lens 60.

The detector (imaging device, imaging section) 49 is arranged in a position into which the detection light reflected from the half mirror 61 is incident. Moreover, a detector calculation section 62 which calculates the detection signal from the detector 49 and outputs it to the computer PC described later, is connected to the detector 49.

For the detector 49, a line sensor may be used, an area sensor may be used, or the line sensor and the area sensor may be used together. Moreover, a CCD may be used, a photomultiplier may be used, or a light intensity detecting element such as a photodiode may be used.

The light quantity monitor 50 is arranged to measure the detection light transmitted through the half mirror 61, and output the measured value to the computer PC.

As described above, the light quantity of the detection light may be measured using the light quantity monitor 50, or the light quantity of the detection light may be measured using an illuminometer, a power meter, or the like.

The heater 40H is arranged on for example, four side faces of the detection section 40, to control the temperature of the inside of the detection section 40 to keep it warm at 30° C. to 37° C., for example. The fan 51 is arranged to convect the air in the detection section 40 so that the temperature in the detection section 40 becomes uniform. Therefore, the temperature in the detection section 40 can be kept at a temperature close to that of the heat insulating box 21, so that the temperature of the heat insulating box 21 can be stabilized more readily.

The cooling fan 52 is driven to decrease the temperature in the detection section 40, based on the output from the temperature sensor (not shown) that is arranged in the detection section 40. Therefore, an abnormal increase in the temperature in the detection section 40 due to the heating of a motor or the like can be prevented.

The detection section 40 having such a structure allows observation of the cells CE similar to with a microscope, such as phase contrast observation, differential interference observation, fluorescence observation, and the like.

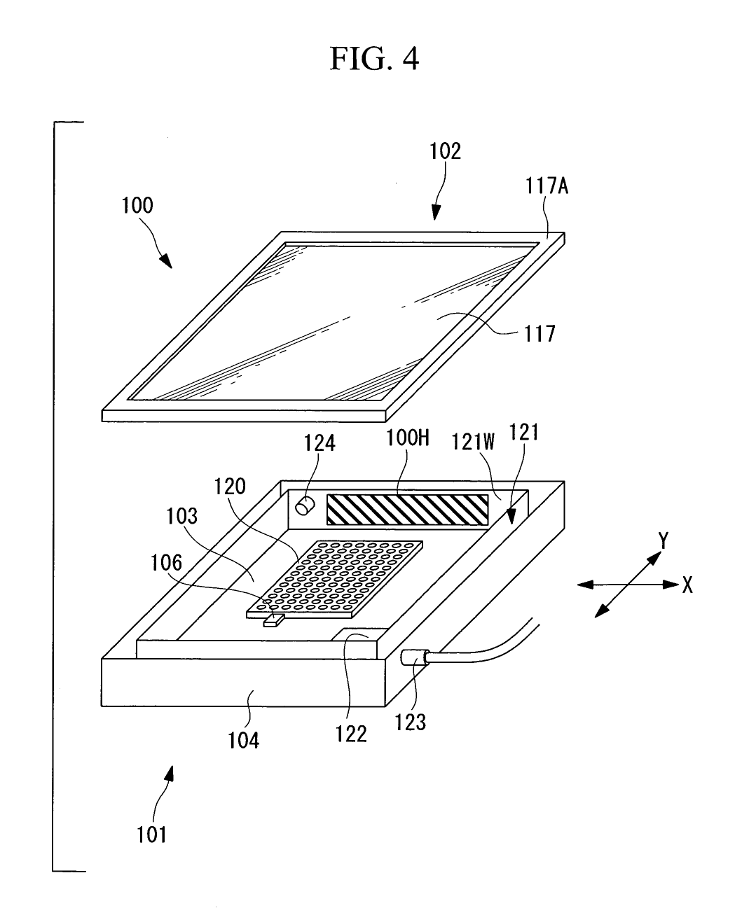

FIG. 4 is a perspective view showing the incubator box according to the present embodiment.

As shown in FIG. 4, the incubator box 100 schematically comprises a box body 101 which stores the microplate 120, and a cover 102 which forms an enclosed space together with the box body 101. A magnetic sealing treatment for shutting out the magnetic field from the outside, and a static elimination treatment for eliminating the static electricity generated in the incubator box 100, are applied to the box body 101 and the cover 102.

The box body 101 is formed from a bottom plate 103 and a side wall 104. The region corresponding to the measurement area on the bottom plate 103 is made from a material having transmittance such as glass. The other region on the bottom plate 103 and the side wall 104 are preferably made from a metal such as an alumite coated aluminum, or a material having a high shading property such as a stainless steel, like SUS316. From the viewpoint of the heat retaining property, it is more preferable to select a material having low heat conductivity.

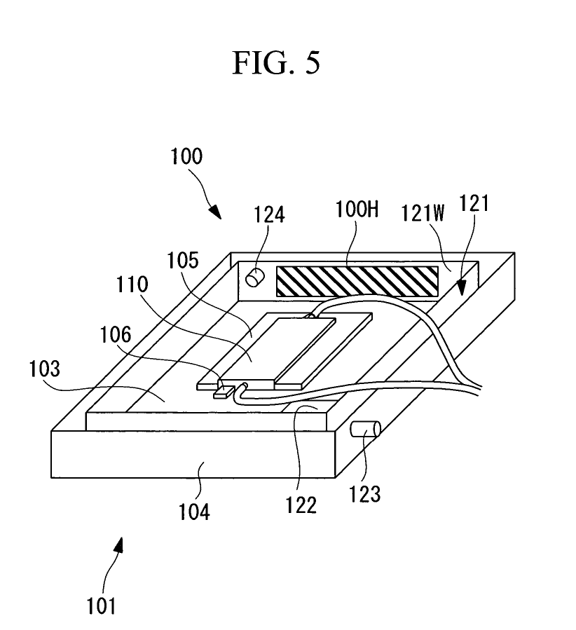

Moreover, a temperature sensor 106 which measures the temperature of the microplate 120 is arranged on the bottom plate 103. When the chamber (culturing container) 110 described later is stored into the incubator box 100, an adaptor 105 (refer to FIG. 5) may be arranged between the bottom plate 103 and the chamber 110 to hold the chamber 110.

Moreover, a water bath 121 enclosing the microplate 120 in a square shape, an internal fan 122 arranged inside of the water bath 121, a connector 123 which supplies a culture gas, a culture gas concentration sensor 124 which detects the carbon dioxide concentration in the culture gas, and a heater (temperature maintaining section) 100H which adjusts the temperature in the incubator box 100 to approximately 37° C., are arranged in the box body 101.

The output from the temperature sensor 106 is inputted into the computer PC via an incubator temperature detection section 106S, and is also inputted into a temperature display section 107 arranged on the wall surface of the detection section 20. The computer PC controls the heater 100H and the like via the incubator temperature control section 106C shown in FIG. 2, so as to control to keep the temperature in the incubator box 100 constant.

The culture gas concentration sensor 124 outputs the carbon dioxide concentration to the computer PC and to the culture gas concentration display section 124D.

The side wall 121W of the water bath 121 is formed lower than the height of the side wall 104. Moreover, the layout for the connector 123 is adjusted so that the supplied culture gas impinges on the side wall 121W. Sterilized water is stored in the water bath 121 to adjust the humidity in the incubator box 100a to approximately 100%.

The internal fan 122 is arranged so as to blow along the side wall 104 of the water bath 121, so that the microplate 120 is not arranged in the flow direction.

The culture gas concentration sensor 124 may be arranged on the inner surface of the side wall 121W of the water bath 121. Alternatively, the pipeline may be arranged from the incubator box 100 to the outside to draw the culture gas in the incubator box 100 by a suction pump so that the culture gas concentration sensor 124 detects the concentration.

The cover 102 comprises a glass plate 117 through which the illuminating light is transmitted, and a support 117A which supports the glass plate 117. Anti-reflection films may be formed on the both sides in a region corresponding to the measurement area. By forming the anti-reflection films on the both sides, the reflection by the glass plate 117 during the transmission observation/incident light observation can be avoided.

The dimensions of the glass plate 117 may be approximately the same as the dimensions of the bottom plate 103 of the incubator box 100, or may be the minimum dimensions required for measurement without problems.

When such an incubator box 100 is used, since there is no necessity to supply the culture solution from the culturing unit 70, the operation of various pumps such as a culture solution pump 80 is stopped.

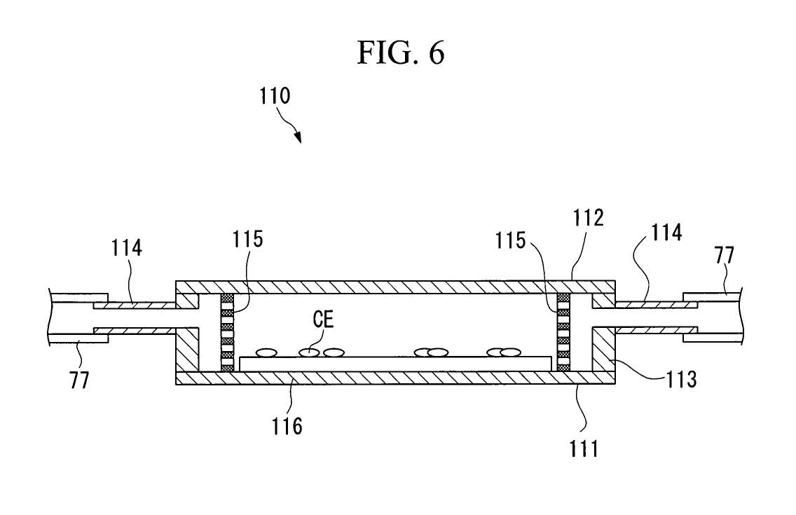

FIG. 5 is a perspective view showing another example of an incubator box according to the present embodiment. FIG. 6 is a cross-sectional view of a chamber according to the present embodiment.

As described above, the incubator box 100 may have the microplate 120 (or a well plate) arranged inside, or may have the chamber 110 arranged inside as shown in FIG. 5.

As shown in FIG. 6, the chamber 110 is schematically formed from a bottom glass member 111 for observing by the object lenses 48, a top glass member 112 for transmitting light from the transmission light source 23, and a frame member 113 which supports the bottom glass member 111 and the top glass member 112.

A joint 114 formed with a passage for letting the culture solution circulate, is formed on the side facing the frame member 113. A culture solution circulation pipeline 77 described later is connected to the joint 114, so that the culture solution circulates between the culturing unit 70 and the chamber 110. Moreover, the destination of the culture gas from the culture gas mixing bath 91 described later is changed from the incubator box 100 to a culture solution bottle 72.

On the frame member 113, a pair of grids 115 which make the flow of the culture solution uniform, are arranged approximately perpendicularly to the flow of the culture solution. The commutator 115 is made from a plate member in which small pores are formed in matrix form, and the culture solution dispersingly flows through a plurality of the formed small pores, by which the flow is made uniform. Moreover, a slide glass 116 having cells CE disseminated thereon, is arranged between the two commutators 115.

In this case, the connector 123 which supplies the culture gas is closed off, and the culture gas concentration sensor 124 is not used. Moreover, if the size of the chamber 110 is different from that of the microplate 120, the chamber 110 may be arranged on the incubator box 100a using the adaptor 105. Furthermore, the sterilized water need not be put into the water bath 121, and the water bath 121 itself may be taken out from the incubator box 100. The temperature sensor 106 measures the temperature of the chamber 110.

The connector 123 may be closed off as described above, or the supply of the culture gas to the incubator box 100 may be simply stopped while the culture gas supply pipeline 97 is connected.

As shown in FIG. 1 and FIG. 2, the culturing unit 70 schematically comprises a sterile box 71 which stores the culture solution inside, and a mixing section 90 which generates the culture gas.

The sterile box 71 comprises; a heater 71H which keeps the inside of the sterile box 71 warm at a predetermined temperature, a culture solution bottle 72 which stores the culture solution inside, a spare tank 73 which stores the spare culture solution inside, a waste tank 74 into which the used culture solution is put, a UV lamp 25 which sterilizes the inside of the sterile box 71, an opening/shutting door 75 which is used for putting in and taking out the culture solution bottle 72 or the like from the sterile box 71, and a main power switch 76 which turns ON/OFF the main power source of the culturing unit 70.

The culture solution bottle 72 is made from a material having excellent thermal conductivity, for example a corrosion-resistant stainless or a glass. A heater (not shown) for the culture solution bottle is arranged at the bottom of the culture solution bottle 72. The culture solution in the culture solution bottle 72 can be kept at approximately 37° C. by the heater for the culture solution bottle.

A culture solution circulation pipeline 77 for letting the culture solution circulate between the incubator box 100 and the culture solution bottle 72, a supply pipeline 78 which supplies the spare culture solution from the spare tank 73, and a waste pipeline 79 which discharges the used culture solution from the culture solution bottle 72 to the waste tank 74, are arranged on the culture solution bottle 72.

A culture solution pump 80 which delivers the culture solution from the culture solution bottle 72 to the incubator box 100 to let the culture solution circulate, is arranged on the culture solution circulation pipeline 77. Since the culture solution in the chamber 110 can be exchanged for a new solution by the culture solution pump 80, the period during which the cells CE can be cultured can be extended compared to the case where the culture solution can not be exchanged.

A supply pump 81 which sends the culture solution from the spare tank 73 to the culture solution bottle 72 is arranged on the supply pipeline 78. A waste pump 82 which sends the used culture solution from the culture solution bottle 72 to the waste tank 74, is arranged on the waste pipeline 79.

For example, a VeriStar pump may be used for the abovementioned culture solution pump 80, supply pump 81, and waste pump 82. A predetermined flow of culture solution can be sent by the VeriStar pump.

As described above, the waste tank 74 which stores the used culture solution, may be used. Alternatively, a drainage port which discharges the used culture solution directly to the outside, may be provided without using the waste tank 74.

A culture solution temperature sensor (not shown) which detects the temperature of the inside of the culture solution is arranged on the culture solution bottle 72, so that the output from the culture solution temperature sensor is inputted into the computer PC via a culture solution temperature detection section 83. Moreover, the data of the temperature of the culture solution inputted into the computer PC is saved into a memory as text data so as to be used for comparison/verification with the detection result of the cells CE.

For the heater 71H, there is arranged a culture solution temperature control section 84 which controls the temperature of the culture solution through the temperature in the sterile box 71 based on the instructions from the computer PC. The temperature of the culture solution supplied from the culture solution bottle 72 is kept at approximately 370C by the culture solution temperature control section 84 to avoid a decrease in the activity of cells CE due to the temperature change of the culture solution. Moreover, a temperature display section 85 which displays the culture solution temperature detected by the abovementioned culture solution temperature sensor, is arranged on the wall surface of the culturing unit 70.

A culture solution pump control section 86 which controls the circulation of the culture solution based on the instructions from the computer PC, is arranged on the culture solution pump 80. Moreover, the supply pump 81 and the waste pump 82 are arranged so that the operation is controlled based on the instructions from the computer PC.

The UV lamp 25 is connected to the UV lamp switch 36 arranged on the wall surface of the culturing unit 70. A timer 37 which controls the operation of the UV lamp 25 timewise is arranged between the UV lamp 25 and the UV lamp switch 36. Furthermore, there is arranged a sterilization indicator lamp (not shown) which indicates if the UV lamp 25 is turned on.

The UV lamp 25 is controlled separately from the main power switch 76, and can be operated even if the main power source is turned off.

As shown in FIG. 1 and FIG. 2, a heater (not shown) which keeps the inside of the mixing section 90 warm at a predetermined temperature, a culture gas mixing bath 91 which controls the carbon dioxide concentration in the culture gas to be supplied to the incubator box 100, and a CO2 pump 93 which supplies carbon dioxide from a CO2 tank 92 arranged outside of the culturing unit 70 to the culture gas mixing bath 91, are arranged in the mixing section 90.

On the culture gas mixing bath 91, a CO2 concentration detection section 94 which detects the carbon dioxide concentration of the inside thereof is arranged, so that the output from the CO2 concentration detection section 94 is inputted to the computer PC. A CO2 concentration control section 95 which controls the amount of carbon dioxide to be supplied to the culture gas mixing bath 91 based on the instruction from the computer PC, is arranged for the CO2 pump 93. Moreover, a CO2 concentration display section 96 which displays the carbon dioxide concentration in the culture gas mixing bath 91 detected by the CO2 concentration detection section 94, is arranged on the wall surface of the culturing unit 70.

Furthermore, a culture gas supply pipeline 97 is arranged between the culture gas mixing bath 91 and the culture solution bottle 72. Therefore, a culture gas can be supplied to the culture solution via the culture gas supply pipeline 97 so as to sufficiently blend the culture gas into the culture solution.

Moreover, as necessary, in order to promote the dissolution of carbon dioxide into the culture solution, for example a magnetic stirrer (not shown) may be arranged on the lower side of the culture solution bottle 72 and a stirrer (not shown) which rotates by the rotation of the magnetic field may be arranged in the culture solution bottle 72. In this manner, by sufficiently blending the carbon dioxide into the culture solution, the pH value of the culture solution can be kept constant.

In this manner, a culture solution with 5% concentration of carbon dioxide dissolved is generated in the culture solution bottle 72, so that the culture solution including culture gas and essential nutrition for growing the cells CE can be supplied to the chamber 110 described later. Moreover, by dissolving the culture gas into the culture solution, the pH and the like of the culture solution can be adjusted.

The carbon dioxide concentration inputted from the CO2 concentration detection section 94 to the computer PC is saved into a memory as data, and data processing is made possible in the computer PC.

Next is a description of an observation method for the biological sample observation system 10 having the abovementioned structure.

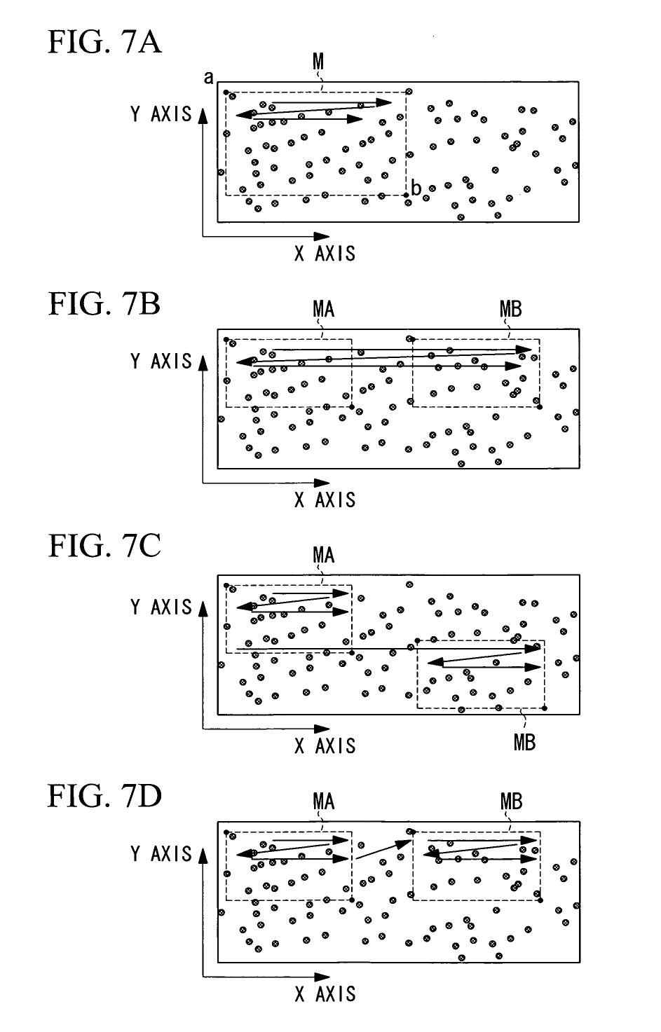

First is a description of the selection for the scan method and the detection range in the present embodiment, with reference to FIG. 7A, FIG. 7B, FIG. 7C, and FIG. 7D.

FIG. 7A, FIG. 7B, FIG. 7C, and FIG. 7D show selected examples of the scan method and the detection range in the present embodiment.

In the example shown in FIG. 7A, a measuring object range M (the range enclosed by broken lines in the drawing) is selected by specifying a point a on the top left and a point b on the bottom right of the measuring object range M on the displayed image. Specifically, the measuring object range M may be selected by dragging between the points a and b using a device such as a mouse, or may be specified by inputting the coordinate value of the point a and the point b.

As shown by the arrows in the drawing, the measurement part for the detector 49 is scanned vertically in the selected measuring object range M. That is, in the drawing, it is scanned in parallel with the X direction when scanned from the left to the right, and it is scanned downwards to the left when scanned from the right to the left. Of these scans, the image of the cells CE is captured when it is scanned from the left to the right.

FIG. 7B is an example for where there are two measuring object ranges M selected by the abovementioned method. Firstly, two measuring object ranges MA and MB are selected by the abovementioned method. In the drawing, the selecting is such that the measuring object range MA and the measuring object range MB are aligned with a predetermined interval in the X direction, and they are wholly overlapped in the Y direction.

As shown by the arrows in the drawing, the measurement part for the detector 49 in this example is scanned to measure the measuring object ranges MA and MB side-by-side. That is, in the drawing, it is scanned from the measuring object range MA to the measuring object range MB when scanned from the left to the right, and it is scanned from the measuring object range MB to the measuring object range MA when scanned from the right to the left.

FIG. 7C is an example for where there are two measuring object ranges selected by the abovementioned method and the arrangement of the two measuring object ranges MA and MB is different. Here, in the drawing, the selecting is such that the measuring object range MA and the measuring object range MB are lined up with a predetermined interval in the X direction, and they are partly overlapped in the Y direction.

As shown by the arrows in the drawing, regarding the measurement part for the detector 49 in this example, only the part of the measuring object ranges MA and MB which is overlapped in the Y direction is continuously scanned. That is, firstly the part of the measuring object range MA which is not overlapped is scanned. Next, the part of the measuring object ranges MA and the MB which is overlapped in the Y direction is continuously scanned. Then, the part of the measuring object range MB which is not overlapped is scanned.

FIG. 7D is an example for where there are two measuring object ranges M selected by the abovementioned method and the arrangement of the two measuring object ranges MA and MB is similar to that of FIG. 7B, but the scan method is different.

As shown by the arrows in the drawing, regarding the measurement part for the detector 49 in this example, the measuring object ranges MA and MB are separately scanned. That is, firstly the measuring object range MA is wholly scanned, and then the measuring object range MB is wholly scanned.

Moreover, among the abovementioned scan methods shown in FIG. 7A, FIG. 7B, FIG. 7C, and FIG. 7D, the scan method by which the total moved distance becomes the shortest is automatically selected by the computer PC, based on a set parameter and measurement mode described later.

Next is a description of the procedure taken to measure the cells CE, using respective flowcharts.

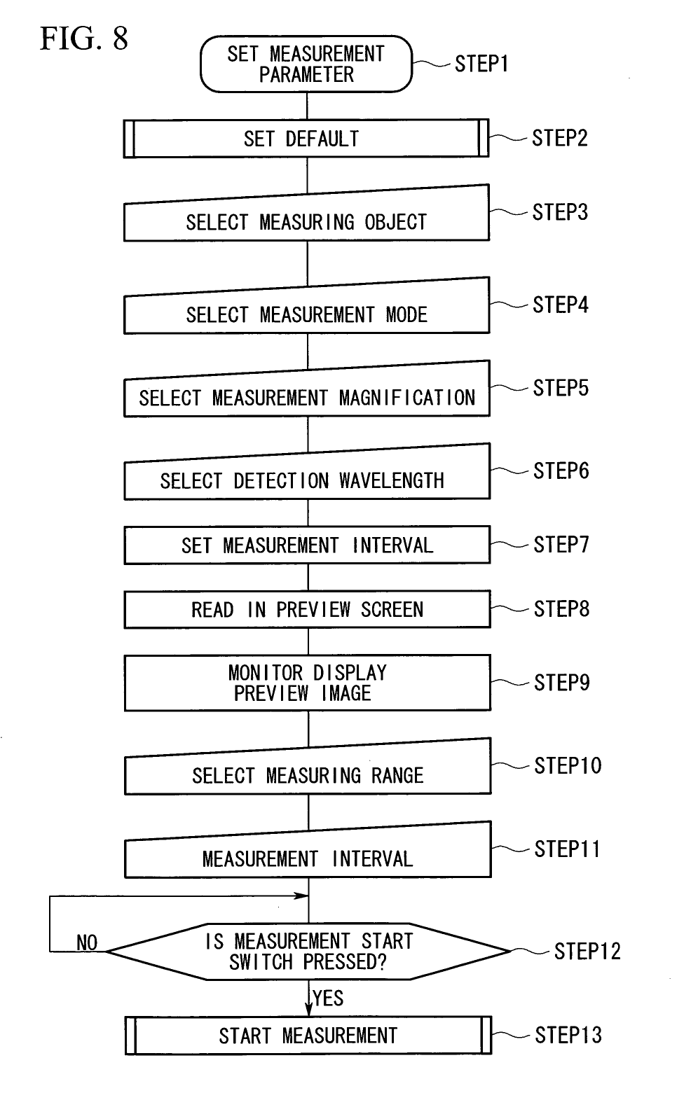

Firstly, the measurement parameter is set prior to the measurement of the cells CE. Here, the flow of the measurement parameter setting is described with reference to FIG. 8.

FIG. 8 is a flowchart describing the flow of the measurement parameter setting in the present embodiment.

Firstly, the measurement parameter is set (STEP 1).

Then, default conditions are set (STEP 2). The conditions set here are for example a measurement condition and a culture condition such as the CO2 concentration is 5% and the temperature is 37° C. These set conditions can be changed into predetermined conditions by a user.

Next, the measuring object is selected (STEP 3). The measuring object is a container of the cells CE such as the microplate 120 or the slide glass 116 for example.

Next, the measurement mode is selected (STEP 4). The measurement mode includes an area imaging mode, a line imaging mode, an automatic mode, and the like. The automatic mode is a mode for automatically selecting a measurement mode in which the measuring time or the scanning time is short, from among the other measurement modes.

When capturing an image of the range where the cells are cultured, if the structure is such that the images of a plurality of regions (detection range) can be separately captured by for example, selecting the measuring object ranges M in this manner, then as necessary it is possible to capture only the image of the necessary part.

For example, if the setting of the computer PC is changed so as to alternatively scan the whole range, being the scanning object, and a predetermined part of the region, a phenomenon peculiar to the biological sample occurring only for a short period can be captured. As an example, in the case where the whole range being the scanning object, is scanned every 30 minutes, if the predetermined measuring object range M where the noteworthy cells are present is scanned during this time, it becomes possible to capture any peculiar phenomenon that appears for only about 15 minutes, occurring in the noteworthy cells.

Moreover, since only the necessary measuring object range M is scanned when needed, the scanning time can be shortened and the light irradiation time to the other cells can be shortened.

Next, the measurement magnification is selected (STEP 5), and then the detection wavelength is selected (STEP 6). In the selection of the measurement magnification, and the selection of the detection wavelength, selection can be made from each of two or more kinds of alternatives.

Here, as the selection method of the detection wavelength, the list of fluorescent proteins to be used, such as GFP, HC-Red, and the like is previously stored in the computer PC, and the fluorescent protein is selected from the stored list. Based on the selected fluorescent protein, the computer PC automatically selects the excitation filter 56, the absorption filter 58, and the like, that is optimum for the observation. In this manner, a predetermined fluorescence from the cells CE can be detected.

During the measurement, the excitation filter 56, the absorption filter 58, the object lenses 48, and the like, are automatically changed in synchronous with the drive of the X axis operation stage 22X, and the Y axis operation stage 22Y.

Next, the measurement interval is set (STEP 7).

Then, the preview image is read in (STEP 8), and the preview image is displayed on the monitor (STEP 9). Here, the preview image is displayed on the monitor under the user's instruction using a preview button which instructs displaying of the preview image on the monitor. Then, the user can confirm the preview image displayed on the monitor.

Next, the measuring range is selected (STEP 10). After the measuring range is selected, the preview image may be displayed on the monitor again so as to confirm that the measuring range is the predetermined range.

Next, a predetermined measurement interval is selected from a plurality of set measurement intervals (STEP 11).

Then, if the measurement start switch (not shown) is pressed (STEP 12), the measurement of the cells CE is started (STEP 13). If the measurement start switch is not pressed, the state remains in standby until the measurement start switch is pressed (STEP 12).

The setting may be such that, if the measurement start switch is not pressed in STEP 12, the flow can return to various predetermined STEPs so as to be able to set various setting again.

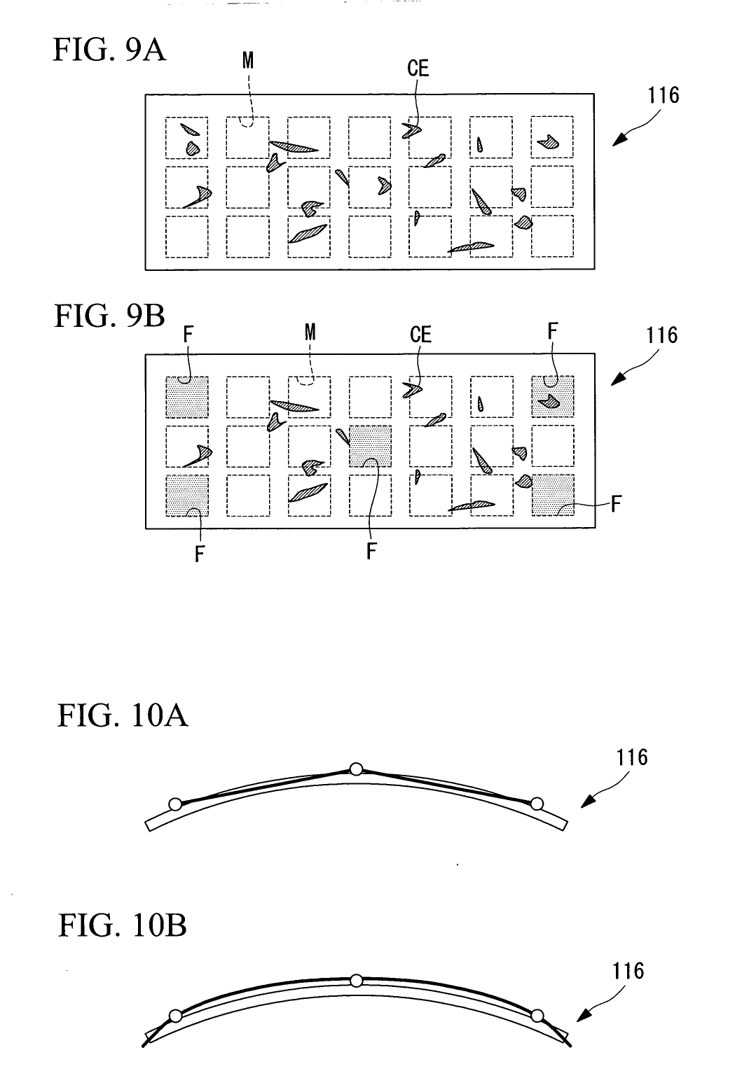

If the measurement parameter setting is completed, then next the cells CE are observed. First is a description of the focus observation area where the focus detection is performed, and a description of the calculation of the movement value of the observation area (observation region) where the observation is performed, but the focus detection is not performed, with reference to FIG. 9A to FIG. 11.

FIG. 9A shows the observation area on the slide glass 116., and FIG. 9B shows the area on the slide glass 116 in which the focal position is measured.

As shown in FIG. 9A, the cells CE are disseminated on the slide glass 116. The biological cell observation system 10 is previously set so as to observe the rectangular regions (observation area M) shown by the dotted lines in the drawing.

Alternatively, as shown in FIG. 9B, the observation areas (focus observation area F) where the focus detection is performed may be selected sparsely. Here, the focus detection is performed in the observation areas M at the four corners and the observation area M in the approximate center of the slide glass 116, to obtain the movement values. Moreover, the focus detection is performed in the focus observation area F, in the order of top left corner, top right corner, approximate center, bottom left corner, and the bottom right corner.

FIG. 10A is a side view of the slide glass 116, for explaining the linear interpolation. FIG. 10B is a side view of the slide glass 116, for explaining the curvilinear interpolation.

As described above, when the movement values of the five focus observation areas F are obtained, the movement values of the observation areas M where the focus detection is not performed are calculated based on the measured value. The calculation includes a calculation method using linear interpolation, and a calculation method using the curvilinear interpolation.

As shown in FIG. 10A, in the calculation method using linear interpolation, the space between the movement values (shown by O in the drawing) of the focus observation areas F is interpolated by a straight line (shown by a solid line in the drawing), to thereby calculate the movement values of the observation areas M where the focus detection is not performed.

As shown in FIG. 10B, in the calculation method using the curvilinear interpolation, the space between the movement values (shown by O in the drawing) of the focus observation areas F is interpolated by a curved line (shown by a solid line in the drawing), to thereby calculate the movement values of the observation areas M where the focus detection is not performed. The curved line used for the calculation may be a quadric curve or a cubic curve, and it is not specifically limited.

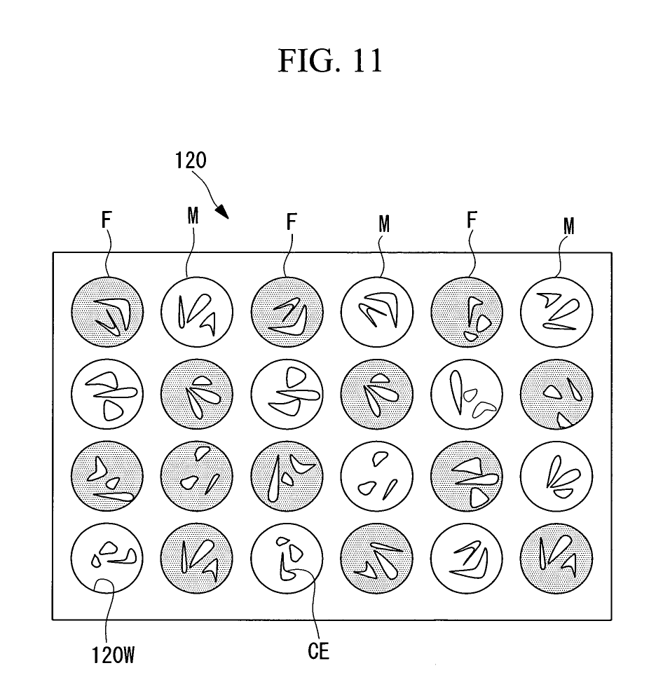

FIG. 11 shows the observation area and the focus observation area on the microplate 120.

As shown in FIG. 11, if the microplate 120 is used, a well 120W where the cells CE are stored becomes the observation area M. Moreover, the focus observation areas F are selected by skipping every other area.

By selecting the focus observation areas F in this manner, even in the case of a microplate 120 larger than the slide glass 116, the occurrence of focal displacement can be prevented, and the amount of focal displacement can be decreased.

Moreover, compared to a case where focus detection is performed for all the wells 120W, the time required for the autofocus operation can be shortened if the focus detection is performed on part of the wells 120W, and the Z coordinates (movement value) of the wells 120W where the focus detection is not performed are obtained by calculation. In the focus detection method, the time shortening effect may be demonstrated more as the number of the observation areas M (wells 120W) is increased. For example, since the number of the wells 120W is generally 384 wells or more, the time shortening effect for the autofocus operation can be more readily demonstrated.

In the focus detection method, the focus observation areas F are selected by skipping every other area. However, they may be selected by skipping two areas at a time, or only the wells 120W at four corners of the microplate 120 may be selected as the focus observation areas F. The selecting can be changed according to the shape of the microplate 120 when the cells CE are observed.

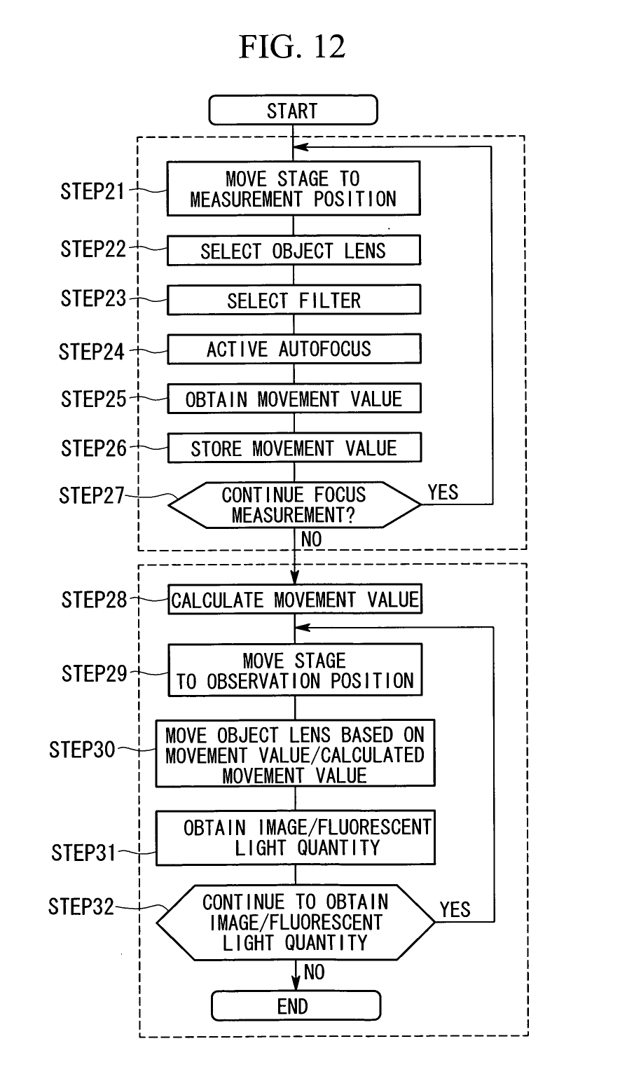

Next is a description of the flow of measurement of the cells CE, with reference to FIG. 12.

FIG. 12 is a flowchart describing the flow of measurement according to the present embodiment.

In the measurement described below, the drive is controlled by the computer PC. Firstly, when the observation of the cells CE is started, the X axis operation stage 22X and the Y axis operation stage 22Y are moved to the measurement position (STEP 21). Here, the previously selected focus observation area F is moved to be positioned above the object lens 48.

Next, the object lens 48 is selected (STEP 22). Here, a predetermined object lens 48 is selected by rotating the revolver 47. Then, the filters 56 and 58 are selected (STEP 23). Here, the filters 56 and 58 are selected according to the measurement wavelength used for the observation.

Then, the active autofocus is performed (STEP 24), and the movement values are obtained (STEP 25). Here, the Z coordinate value (movement value) of the object lens 48 which becomes the focal position, is obtained.

The obtained movement values are stored in the computer PC (STEP 26), and the abovementioned operation is repeated until the movement values of all of the previously selected focus observation areas F are obtained (STEP 27).

Once obtaining of the movement values for the selected focus observation areas F has been completed, the movement values of the observation areas M between the focus observation areas F are calculated by the computer PC using linear interpolation or curvilinear interpolation (STEP 28).

Then, the X axis operation stage 22X and the Y axis operation stage 22Y are moved to the observation position (STEP 29). Here, the observation area M is moved to be positioned above the object lens 48.

Then, based on the movement values obtained in STEP 25 and STEP 28, the object lens 48 is moved (STEP 30), and the image or the fluorescent light quantity in the observation area M is obtained/captured (STEP 31).

The operation from STEP 29 to STEP 31 is repeated until the observation of the previously selected observation areas M is completed (STEP 32). When the observation of all of the observation areas M is completed, the observation of the cells CE is terminated.

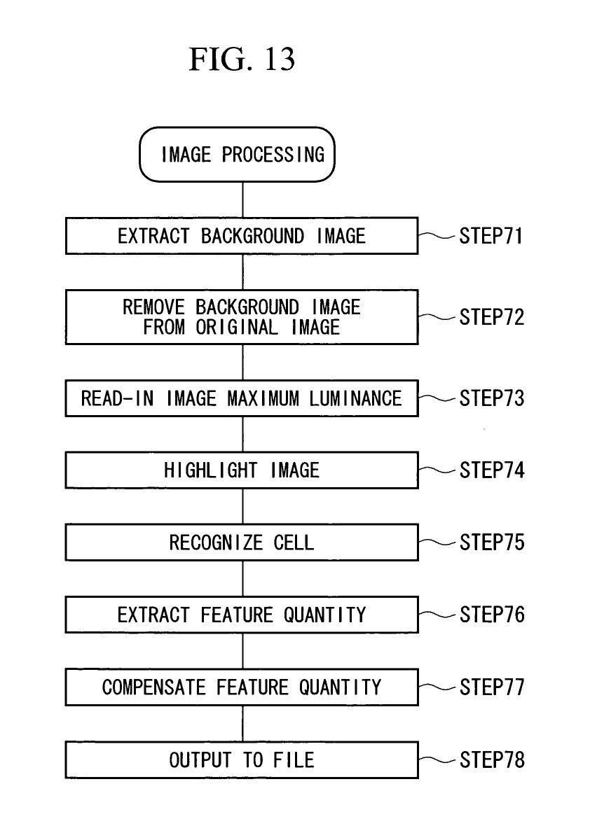

Once the observation/capturing the image of the cells CE has been terminated, then next the captured image is processed. Here is a description of the processing method of the captured image, with reference to FIG. 13.

FIG. 13 is a flowchart describing the image processing method.

Firstly, the image processing section of the computer PC recognizes the background image from the captured image stored in the memory section (STEP 71), and removes the background image (background) from the captured image (STEP 72).

Next, the maximum luminance range of a highlitable image is read-in (STEP 73), and the image is highlighted for example by multiplying by a predetermined coefficient according to the maximum luminance range (STEP 74). By these processings, the image is highlightened from the image for which the background has been removed, so that the cells CE can be readily recognized in the granular form one by one.

Then, by extracting parts having for example the luminance of a predetermined threshold or more from the highlightened image, the luminance of each cell CE can be recognized in a clear granular form one by one (STEP 75).

Next, a geometrical feature quantity such as the position of the center of gravity or the area, a chemical feature quantity, an optical feature quantity such as fluorescent luminance of the cell CE, are accurately recognized and extracted in association with the information of the position of the cell CE (STEP 76). By extracting the feature quantities, the cells CE can be recognized one by one.

After the extraction of the feature quantities of the cells CE, the highlighting operation (STEP 74) that has been performed to recognize the cells CE is compensated for (STEP 77). By this compensation, the effect of the predetermined coefficient used for highlighting the image is eliminated.

Next, the compensated feature quantities are outputted, for example to a file, and stored in the file (STEP 78).

Therefore, the image processing section of the computer PC can form the image of the distribution of the fluorescent light quantity of the cells CE in the respective positions on the whole surface of the slide glass, the microplate, or the like. Moreover, since the image processing section can trace the cells CE accurately one by one, it is possible to focus on a predetermined number of cells CE and locally measure the fluorescent distribution inside of the cells CE for a long time while culturing them. Furthermore, it is also possible to measure the whole surface of the slide glass, the microplate, or the like at each fixed timing while culturing the cells CE, so as to automatically measure the fluorescent light quantity of the cells CE with respect to the passage of time.

As described above, firstly in STEP 21 to STEP 27, the computer PC performs the focus detection of the object lens 48 using the AF unit 46. Then, in STEP 28 to STEP 32, the computer PC continuously observes, using the detector 49, a plurality of different observation areas M, based on the obtained focusing of the object lens 48. Part-way through the observation, the focus detection using the AF unit 46 is not performed (i.e., the focus detection using the AF unit 46 does not intervene), and the observation areas M are continuously observed by the detector 49.

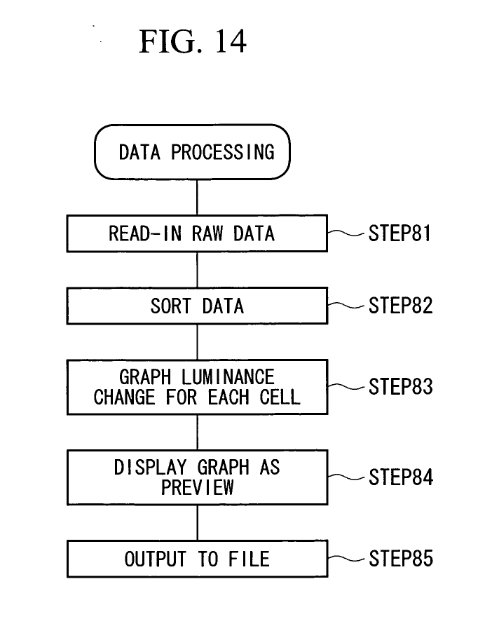

Next is a description of the data processing performed after extraction of the data such as the feature quantities of the cells CE from the captured image, with reference to FIG. 14.

FIG. 14 is a flowchart describing the flow of data processing.

Here, the data (feature quantities) of the cells CE stored in the file by the data processing section of the computer PC are processed.

Firstly, the data processing section reads-in the raw data (feature quantities) of the cells CE stored in the file (STEP 81), and the data is sorted so as to be arranged in time series for each cell (STEP 82). After the data is sorted, the data processing section graphs the change with time of the luminance, that is, the expression level, for each cell CE (STEP 83).

When the graph is completed, the data processing section displays the graph as a preview (STEP 84), and the graphed data is outputted to the file (STEP 85).

By performing the processing, the change with time of a cell for where the cells CE have been cultured for a long time, can be readily observed. Consequently, the change with time of the expression level of the cells CE during the culturing and the like can be accurately and readily measured.

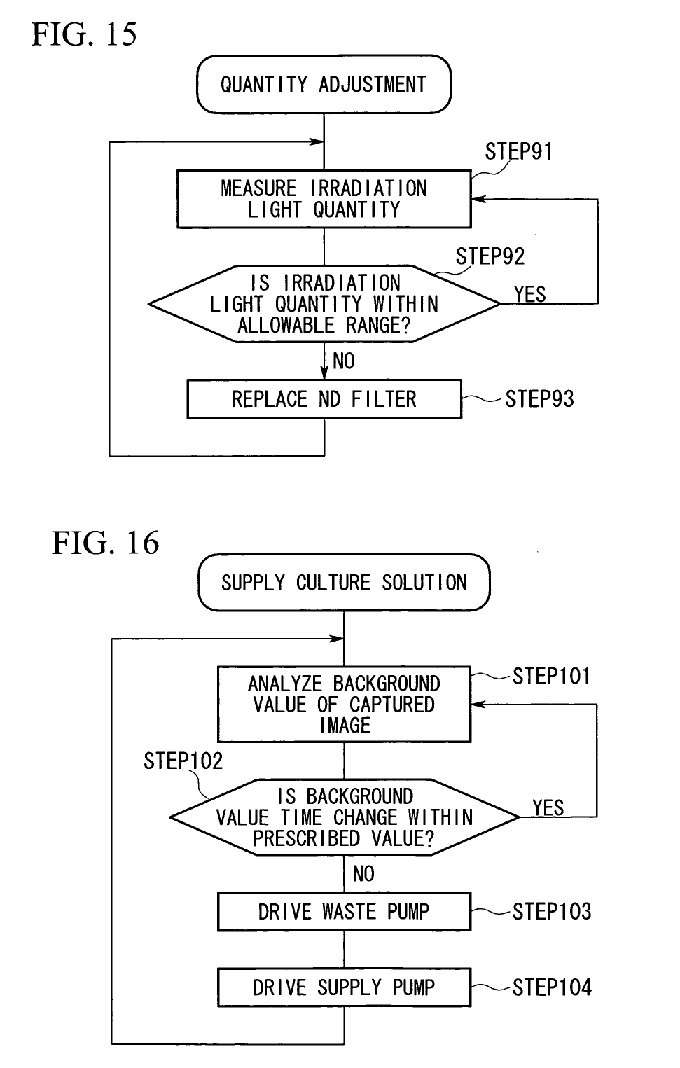

Next is a description of the adjustment of the irradiation light quantity performed at the time of measuring the cells CE, with reference to FIG. 15.

FIG. 15 is a flowchart describing the flow of light quantity adjustment.

Firstly, the light quantity of the light irradiated onto the cells CE is measured (STEP 91). The irradiation light quantity may be calculated from the output of the light quantity monitor 50, may be measured by providing an illuminometer, or may be calculated by providing a power meter and calculating from the output of the power meter.

If the measured irradiation light quantity is within the allowable range, the flow returns to the measurement of the irradiation light quantity (STEP 91), and the measurement is repeated until the irradiation light quantity becomes outside of the allowable range (STEP 92).

When the irradiation light quantity becomes outside of the allowable range, the ND filter (not shown) included in the light quantity adjustment mechanism 43 is replaced (STEP 93), and the irradiation light quantity is adjusted so as to be within the allowable range. Then, the flow returns to the measurement of the irradiation light quantity (STEP 91), and the adjustment of the irradiation light quantity is repeated.

Next is a description of a control method for supplying/exchanging a culture solution to the chamber 110, with reference to FIG. 16.

FIG. 16 is a flowchart describing the supplying/exchanging method of a culture solution.

Firstly, the background value of the captured image is analyzed (STEP 101). In the background of the captured image, the image of autofluorescent light from the culture solution is captured, and the luminance of the autofluorescent light from the culture solution is analyzed.

Here, since the luminance of the autofluorescent light becomes higher as the culture solution gets older, the timing for exchanging the culture solution can be detected by measuring the luminance of the autofluorescent light.

If the change with time in the analyzed background value is a predetermined prescribed value or less, the flow returns to the analysis of the background value (STEP 101), and the analysis is repeated until the change with time in the background value becomes greater than the predetermined prescribed value (STEP 102).

When the change with time in the background value becomes greater than the predetermined prescribed value, the waste pump 82 of the culture solution is driven (STEP 103), and the supply pump 81 of the culture solution is driven (STEP 104).

The timing of supplying/exchanging the culture solution may be determined by the autofluorescent light from the culture solution as described above, or may be continual, or the supplying/exchanging may be automatically performed at a time interval previously specified by the user. Alternatively, the time for exchanging the culture solution may be appropriately specified by selecting a cell CE from a previously registered table. Moreover, the amount to be exchanged may be set by the user, may be determined by the autofluorescent light from the culture solution, or all of the culture solution in the chamber 110 may be exchanged. Alternatively, the amount of the culture solution to be exchanged may be appropriately specified by selecting a cell CE from a previously registered table. Moreover, it may be automatically set by converting by weight.

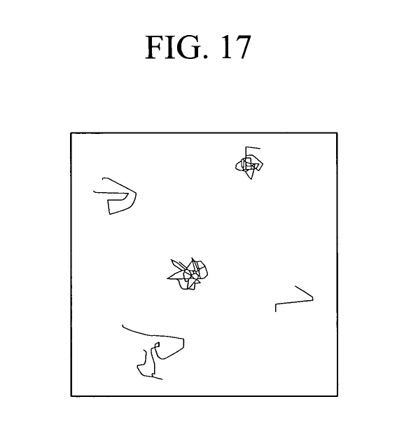

By the abovementioned measurement procedure, as shown in FIG. 17, a tracked image of the cells showing the change of the cells one by one with the passage of time can be obtained.

According to the above structure, since the autofocus operation is performed on the focus observation areas F prior to the observation of the observation areas M, and then the observation areas M are observed based on the movement values obtained from the result, the time required for the observation of the cells CE can be shortened, and the observation can be performed quickly.

Moreover, by reducing or controlling the expansion, contraction, and deformation due to the change in the thermal environment of the components related to the observation and focusing, using the heaters 21H, 40H, and 100H, the displacement of the focal position can be prevented or reduced, and the cells CE can be accurately observed.

Since the focus observation areas F are part of the observation areas M, the time required for the autofocus operation can be shortened compared to the case where the autofocus operation is performed for all observation areas M.

Moreover, since no light is irradiated on the observation areas M other than the focus observation area F, in the autofocus operation, the decrease in the activity of the cells CE can be prevented, in the case where for example, the cells CE are such cells for which activity is decreased by light irradiation.

Since the time required for the observation of the cells CE can be shortened, the light irradiation time onto the cells CE can be shortened. For example, in the case where the cells CE are such cells for which activity is decreased by light irradiation, the decrease in the activity of the cells CE can be prevented and an accurate observation result for the cells CE can be obtained.

Moreover, since the time required for the observation can be shortened, if a large number of observation areas M are measured such as on the microplate 120, the time interval between the time when the first observation area M is measured and the time when the last observation area M can be shortened, and accurate observation results which can be compared with a set of information obtained from the observations, can be obtained.

Since the object lenses 48 are arranged to be opposed to the cells CE through the microplate 120 or the chamber 110, the cells CE can be observed without taking the cells CE out from the microplate 120 or the chamber 110. Therefore, a decrease in the activity of the cells CE can be prevented even with long time observation.

Since the movement values of the observation areas M other than the focus observation areas F can be calculated based on the movement values of the focus observation areas F, all observation areas M can be observed based on the movement values. Therefore, compared to the case where the calculation is not performed, the occurrence of the focal displacement in the observation of the observation areas M can be prevented or the amount of the focal displacement can be decreased.

Moreover, even if the cells CE are observed using the microplate 120 or the chamber 110 having poor flatness for example, the autofocus operation on all observation areas M is not performed by calculation, and the occurrence of the focal displacement can be prevented or the amount of the focal displacement can be decreased.

### Second Embodiment

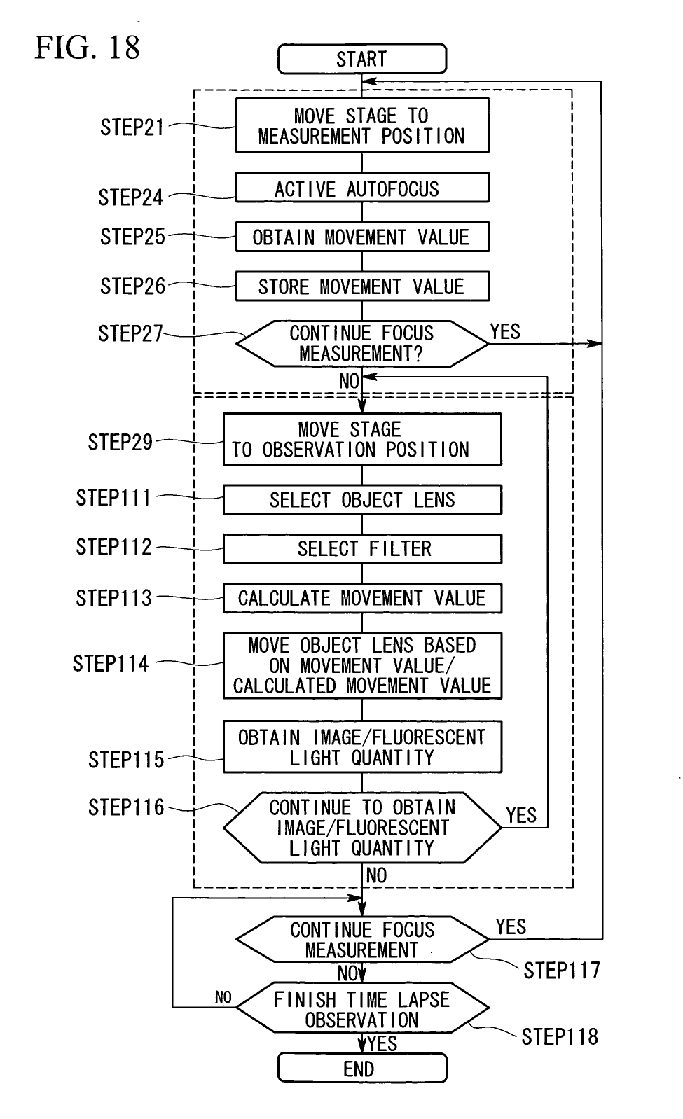

Next is a description of a second embodiment of the present invention, with reference to FIG. 18.

The basic structure of the biological sample observation system of the present embodiment is similar to that of the first embodiment. However, the difference from the first embodiment is the point that a time lapse observation is performed. Therefore, in the present embodiment, the procedure for time lapse observation is described using FIG. 18, and the description of the structure of the biological sample observation system and the like is omitted.

FIG. 18 is a flowchart showing the flow of the procedure for time lapse observation according to the present embodiment.

For the same observation procedures as those of the first embodiment, the same reference symbols are used, and the description thereof is omitted.

Firstly, as shown in FIG. 18, when the observation of the cells CE is started, the X axis operation stage 22X and the Y axis operation stage 22Y are moved to the measurement position (STEP 21).

Then, the active autofocus is performed (STEP 24), and the movement values are obtained (STEP 25).

The obtained movement values are stored in the computer PC (STEP 26), and the abovementioned operation is repeated until the movement values of all of the previously selected focus observation areas F are obtained (STEP 27).

Then, the X axis operation stage 22X and the Y axis operation stage 22Y are moved to the observation position (STEP 29).

Next, the object lens 48 is selected (STEP 111), and the filters 56 and 58 are selected (STEP 112).

Then, the movement values of the observation areas M between the focus observation areas F are calculated by the computer PC using linear interpolation or curvilinear interpolation (STEP 113).

Based on the movement values obtained in STEP 25 and STEP 113, the object lens 48 is moved (STEP 114), and the image or the fluorescent light quantity in the observation area M is obtained (STEP 115).

The operation from STEP 29 to STEP 115 is repeated until the observation of the previously selected observation areas M is completed (STEP 116).

Then, after the passage of a predetermined time, the flow returns to STEP 21, in which focal position measurement and the autofocus operation of all focus observation areas F are performed (from STEP 21 to STEP 27), and the movement values stored in the computer PC are updated. Then, the image or the fluorescent light quantity of the cells CE is obtained based on the updated movement values (STEP 117).

The abovementioned procedure is repeated during the time set in the time lapse observation (STEP 118), and the observation is continued.

As described above, firstly in STEP 21 to STEP 27, the computer PC performs the focus detection of the object lens 48 using the AF unit 46. Then, in STEP 29 to STEP 116, the computer PC continuously observes, using the detector 49, a plurality of different observation areas M, based on the obtained focusing of the object lens 48. Part-way through the observation, the focus detection using the AF unit 46 is not performed (i.e., the focus detection using the AF unit 46 does not intervene), and the observation areas M are continuously observed by the detector 49.

Moreover, as shown in STEP 118, the computer PC can control to repeat the focus detection of the object lens 48 and the continuous observation of the observation areas M which are different from each other. In the continuous observation, the focus detection is not performed part-way through the observation (is clamped part-way through).

According to the above structure, the cells CE can be grown for several days to several weeks in the incubator box 100. Therefore, the time lapse observation can be performed for a long time while culturing the cells CE.

When performing the time lapse observation, the time required for observing all observation areas M can be shortened by performing the autofocus operation by the abovementioned procedure.

As in the abovementioned procedure, the number of times for the autofocus operation and the number of times for the observation operation of the cells CE may the same and the autofocus operation and the observation operation of the cells CE can be mutually arranged. The number of times for the autofocus operation may be less than the number of times for the observation operation of the cells CE.

For example, specifically, the autofocus operation is performed in the morning, noon, evening, and night to update the movement values, and the observation areas M can be observed at a predetermined time interval that was previously set during the autofocus operation.

Moreover, since the latest movement values obtained by the autofocus operation and the latest movement values obtained by calculation are stored, the observation areas M can be observed based on the latest movement values.

Therefore, even if thermal deformation or the like occurs in the components of the detection unit 20, leading to the occurrence of focal displacement with respect to the observation areas M, the focal displacement can be reduced compared to the case where the movement values are not updated to the latest values.

The technical scope of the present invention is not limited to the above embodiments, and various modifications may be made without departing from the scope of the present invention.

For example, in the above embodiments, the description is for where the invention is suitable for a structure where the cells are observed. However, it is not limited to the structure where the cells are observed, but can be suitable for a structure where bacteria, microorganisms, eggs, or various kinds of other biological samples are observed.

What is claimed is:

1. A biological sample observation system which continuously obtains information on a biological sample that is cultured inside of a culturing container comprising:
an imaging section which observes mutually different regions that are previously selected, among regions to be observed including the biological sample, through an object lens for observing the biological sample in the culturing container through a part of the culturing container;
an autofocus section which detects the focusing of the object lens with respect to a predetermined region among the regions to be observed; and
a focusing drive control section which controls the focusing of the object lens when the biological sample is observed using the imaging section, based on the detection result of the focusing previously performed by the autofocus section,
and after the focus detection is performed by the autofocus section, without being intervened by the focus detection using the autofocus section, and the different regions are continuously observed by the imaging section, with the focusing controlled by the focusing drive control section.

2. A biological sample observation system according to claim 1, wherein the autofocus section detects the focusing of the object lens with respect to a plurality of regions among the regions to be observed.

3. A biological sample observation system according to claim 1, wherein the autofocus section detects the focusing of the object lens a number of times less than the number of regions in which the observation is performed by the imaging section.

4. A biological sample observation system according to claim 1, wherein the autofocus section detects the focusing of the object lens with respect to a region in which the observation is performed by the imaging section.

5. A biological sample observation system according to claim 4, wherein the autofocus section detects the focusing of the object lens a number of times less than the number of regions in which the observation is performed by the imaging section.

6. A biological sample observation system according to claim 1, comprising a focusing drive section which relatively moves a position of the object lens with respect to the biological sample, based on control of the focusing drive control section.

7. A biological sample observation system according to claim 1, wherein the detection results of the focusing previously performed by the autofocus section are sequentially stored in the focusing drive control section, and
focusing of the object lens by the focusing drive control section is controlled based on the stored results.

8. A biological sample observation system according to claim 7, wherein the detection result for which the focusing detection has been performed with respect to the same parts among the regions to be observed, is updated to the latest of the detection results.

9. A biological sample observation system according to claim 1, wherein the biological sample is observed over a predetermined period of time.

10. A biological sample observation system according to claim 9, wherein the focus detection by the autofocus section, and the observation continuously performed for mutually different regions by the imaging section, are repeated.

11. A biological sample observation system according to claim 1, wherein based on a value related to the focusing of the object lens obtained from the focusing detection results for part of a region, among the regions to be observed, the focusing with respect to another of the regions is calculated using linear or curvilinear interpolation.

12. A biological sample observation system according to claim 11, wherein focusing of the object lens by the focusing drive control section is controlled based on a value detected by the interpolation.

13. A biological sample observation system according to claim 1, further comprising a temperature maintaining section which maintains at least the culturing container at a substantially constant temperature.

14. A biological sample observation system according to claim 13, wherein the temperature maintaining section furthermore maintains at least one of the object lens, the autofocus section, and the imaging section, at a substantially constant temperature.

15. A biological sample observation system according to claim 1, wherein the biological sample includes a cell.

16. A biological sample observation system which continuously obtains information on a biological sample that is cultured inside of a culturing container comprising:
an observation device which observes mutually different regions that are previously selected, among regions to be observed including the biological sample, through an object lens for observing the biological sample in the culturing container through a part of the culturing container;
an autofocus device which detects the focusing of the object lens with respect to a predetermined region among the regions to be observed; and
a focusing drive control device which controls the focusing of the object lens when the biological sample is observed using the observation device, based on the detection result of the focusing previously performed by the autofocus device,
and after the focus detection is performed by the autofocus device, without being intervened by the focus detection using the autofocus section, and the mutually different regions are continuously observed by the observation device, with the focusing controlled by the focusing drive control device.

17. A biological sample observation method in which information on a biological sample that is cultured inside of a culturing container is continuously obtained comprising:
a step for detecting by an autofocus section, the focusing of an object lens for observing a biological sample through a part of the culturing container, with respect to a predetermined region among the regions to be observed including the biological sample in the culturing container;
a step for controlling by a focusing drive control section, the focusing of the object lens when the biological sample is observed, based on the detection result of the focusing previously performed by the autofocus section; and
a step for observing through the object lens by an imaging section, mutually different regions that are previously selected, among the regions to be observed, with the focusing controlled by the focusing drive control section,
and after the focus detection is performed by the autofocus section, without being intervened by the focus detection using the autofocus section, and the different regions are continuously observed by the imaging section, with the focusing controlled by the focusing drive control section.
